(19) United States
(12) Patent Application Publication
(10) Pub. No.: US 2018/0022770 A1
(43) Pub. Date: Jan. 25, 2018

(54) METAL COMPLEXES AND A PROCESS OF PREPARING THEM

(71) Applicant: XiMo AG, Horw/Lucerne (CH)

(72) Inventors: Georg Frater, Ebnat Kappel (CH); Henrik Gulyas, Budapest (HU); Levente Ondi, Veresegyhaz (HU)

(21) Appl. No.: 15/556,268

(22) PCT Filed: Mar. 8, 2016
(86) PCT No.: PCT/IB2016/051295

§ 371 Date: Sep. 6, 2017

(30) Foreign Application Priority Data
Mar. 9, 2015 (GB) 1503926.6

(51) Int. Cl. C07F 11/00; C08G 61/02

(52) U.S. Cl. CPC C07F 11/00; C08G 61/02; C08G 2261/11; C08G 2261/3325; C08G 2261/418

(57) ABSTRACT

A compound of the formula II (I) in which X is substituted pyrrolide with the general structure of (II) in which R^{a}-R^{d} are independently selected from H, C1-C4 alkyl, C1-C4 alkoxy, aryl, aryloxy, dialkylamino, diarylamino, halogen, trifluoromethyl, cyano, nitro, sulfonyl and sulfinyl. Y is C1-C6 alkoxy, C1-C10 aryloxy, optionally substituted; R¹ is selected from H, C1-C12 alkyl and 5- to 18-membered aryl, optionally substituted; R² is selected from C1-C12-alkyl, 5- to 18-membered aryl, optionally substituted; R³ is selected from C1-C12 alkyl, 5- to 18-membered aryl, optionally substituted; and 15 12⁴-R11 are independently selected from H, C1-C4 alkyl and halogen. The compounds are particularly effective precursors of metathesis catalysts for the polymerisation of dicyclopentadiene.

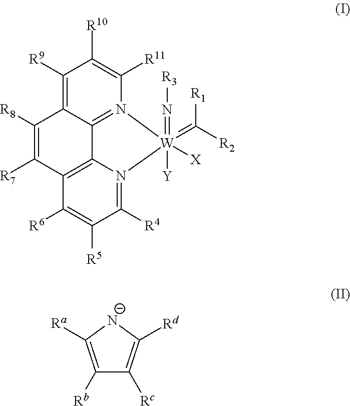

This disclosure relates to metal complexes and to a process of preparing them.

Complexes of molybdenum and tungsten have been used as catalysts for certain chemical reactions, including olefin synthesis. They have the advantage of performing at least as well as ruthenium catalysts while being considerably cheaper (a function of the relative abundance of tungsten and molybdenum). A typical example of such a catalyst is the so-called Schrock catalyst, a typical example of which is shown below:

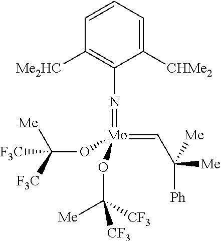

A more recent development is described in Angew. Chem. Int. Ed. 2011, 50,8829-7832, and in PCT published application WO 2012/116695. The metal complex has the Formula (I):

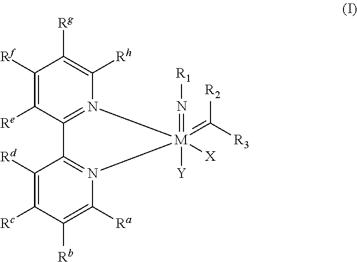

in which M is W or Mo and X and Y are the same or different.

It has now been found that a particular compound not specifically described in any publication has particularly desirable properties. There is therefore provided a compound of the formula II

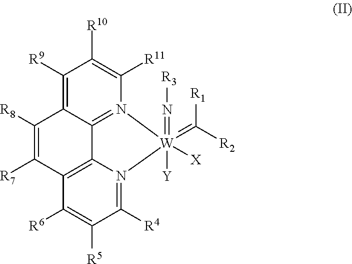

in which
X is substituted pyrrolide with the general structure of

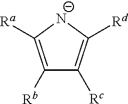

in which R^{a}- R^{d} are independently selected from H, C1-C4 alkyl, C1-C4 alkoxy, aryl, aryloxy, dialkylamino, diarylamino, halogen, trifluoromethyl, cyano, nitro, sulfonyl and sulfinyl;

Y is selected from C1-C6 alkoxy and C1-C10 aryloxy, both of which may be substituted with alkoxy, aryloxy, dialkylamino, diarylamino, halogen, trifluoromethyl, cyano, nitro, sulfonyl and sulfinyl R¹ is selected from H, C1-C12 alkyl and 5- to 18-membered aryl, both of which may be substituted with one or more of C1-C12-alkyl, 5- to 18-membered aryl, C1-C12-alkyloxy, di-(C1-C4-alkyl)amino, halogen, trifluoromethyl, cyano and nitro residues;

R² is selected from C1-C12-alkyl and 5- to 18-membered aryl, both of which may be substituted with one or more of C1-C12 alkyl, 5- to 18-membered aryl, C1-C12-alkyloxy, di(C1-C4alkyl)amino, halogen, trifluoromethyl, cyano, nitro residues;

R³ is selected from C1-C12 alkyl and 5- to 18-membered aryl, both of which may be substituted with one or more of C1-C12 alkyl, 5- to 18-membered aryl, C1-C12-alkoxy, di(C1-C4-alkyl)amino, halogen, trifluoromethyl, cyano and nitro residues; and,

R⁴-R¹¹ are independently selected from H, C1-C4 alkyl and halogen; and

W is selected from Mo and W.

In this description, wherever the terms are used, “alkyl” and “alkoxy” encompass instances in which the alkyl entity is linear, branched or cycloalkyl, and “aryl” encompasses heteroaryl entities.

In a particular embodiment:
in X, R^{b} and R^{c} are H, and R^{a} and R^{d} are independently selected from H, methyl and phenyl;
R¹ and R² are selected from H, C1-C5 alkyl and 5- to 10-membered aryl, which may be substituted with one or more of C1-C4-alkyl, halogen and trifluoromethyl, with the proviso that only one of R¹ and R² can be H;
R³ is selected from C1-C5 alkyl and 5-to 10-membered aryl, both of which may be substituted with one or more of C1-C4 alkyl, 5- to 10-membered aryl and C1-C4-alkoxy,
R⁴-R¹¹ are independently selected from H, C1-C4 alkyl and halogen.

In a further particular embodiment:
in X, R^{b} and R^{c} are H, and R^{a} and R^{d} are both methyl or both phenyl;
R¹ and R² are selected such that one of them is H and the other is selected from C1-C5 alkyl and 5- to 10-membered aryl, which may be substituted with one or more of C1-C4-alkyl, halogen and trifluoromethyl;
R³ is selected from C1-C5 alkyl and 5- to 10-membered aryl, which may be substituted with one or more of C1-C4 alkyl, 5- to 10-membered aryl, C1-C4-alkoxy, halogen, and trifluoromethyl;
R⁴-R¹¹ are hydrogen.

In particular embodiments, the compound hereinabove described is selected from compounds of the Formulae III, IV, V and VI:

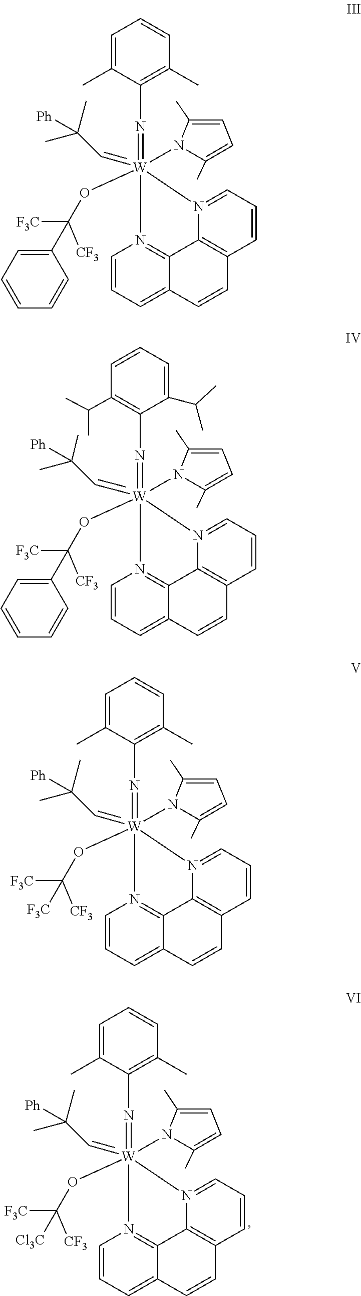

more particularly the compounds of the Formulae III, IV and V

The compounds of Formula II may be made according to the following general scheme:

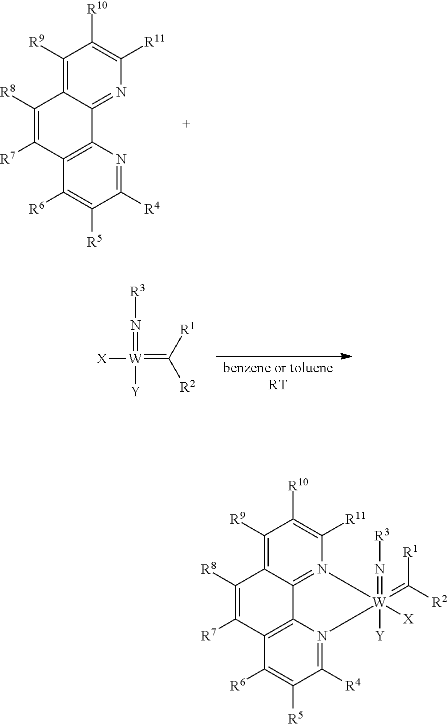

In particular, the compound of Formula III is made according to the following scheme:

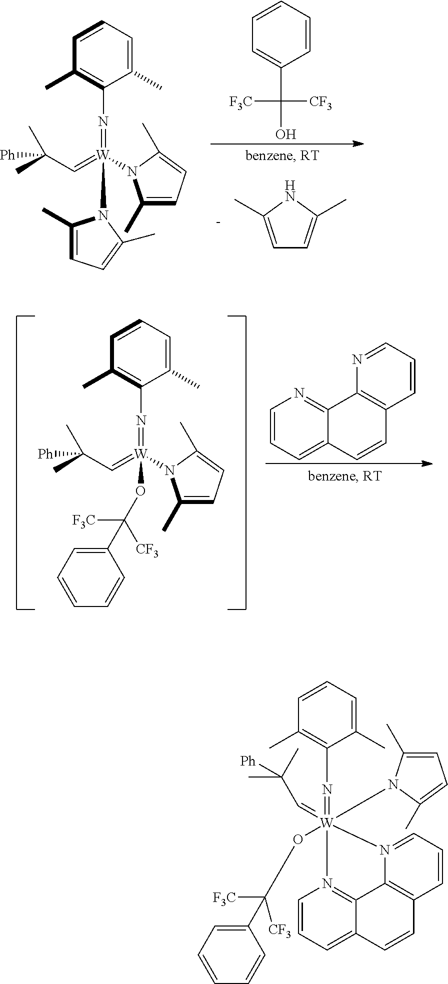

The starting materials for the preparation of the compounds according to Formula II may be easily prepared according to known methods. Such methods may be found, for example in the paper of Jiang et al (J. Am. Chem. Soc. 2009, 131, 16630-16631).

These compounds have been found to be particularly useful in the catalysis of ring-opening metathesis polymerisation reactions, particularly of dicyclopentadiene. The resulting polydicyclopentadiene has a structure of unusual and desirable stereoregularity. There is therefore also provided the use of a compound of the Formula (II) as hereinabove defined in the preparation of a polymer of dicyclopentadiene.

The catalysts are generated in situ from the compounds of Formula II by art-recognised methods, such as the addition of Lewis acids, typically zinc chloride.

Poly(dicyclopentadiene) (PDCPD) made utilising the compounds hereinabove described is distinguished by having a particularly high cis-content. In the corresponding hydrogenated PDCPD the ratio of racemo diads is at least 75%, and in many cases can exceed 90%, and they are syndiotactic. This stereoregularity provides the hydrogenated PDCPD with a high degree of crystallinity, which in turn confers excellent physical properties, such as high melting point, improved impact resistance, corrosion resistance and heat resistance. PDCPD and hydrogenated PDCPD have a number of mechanical and optical uses.

In contrast, catalysts described in Angew. Chem. Int. Ed. 2011, 50, 8829-7832, and in PCT published application WO 2012/116695, yield PDCPD and hydrogenated PDCPD with low syndiotacticity. For instance, in the hydrogenated PDCPD prepared using Mo(CHCMe₂Ph)(NAr^{diiPr})(OCMe(CF₃)₂)₂(1, 10-phenantroline) the ratio of racemo diads was found to be 39%, and it was not syndiotactic (iso-biased). DSC analysis of the hydrogenated PDCPD showed no melting point, suggesting that the polymer was amorphous. (Ar^{diiPr}=2,6-diisopropyl-phenyl; the complex is an example described in Angew. Chem. Int. Ed. 2011, 50, 8829-7832, and in PCT published application WO 2012/116695.)

The measurement of the polymer parameters are typically performed by the following methods:

(1) Number average molecular weight of dicyclopentadiene ring-opening polymer
The ratio of the number of hydrogen atoms present at the terminals of the polymer chain to the number of hydrogen atoms present in the polymer chain excluding the terminals was calculated based on the 1H-NMR measurement results, and the number average molecular weight of the dicyclopentadiene ring-opening polymer was calculated based on the calculated ratio.

(2) Cis/trans content in dicyclopentadiene ring-opening polymer
The cis/trans content in the dicyclopentadiene ring-opening polymer was calculated based on the 1H-NMR measurement results.

(3) Hydrogenation ratio of dicyclopentadiene ring-opening polymer during hydrogenation reaction
The hydrogenation ratio of the dicyclopentadiene ring-opening polymer during the hydrogenation reaction was calculated based on the 1H-NMR measurement results.

(4) Thermal behaviour of hydrogenated syndiotactic crystalline dicyclopentadiene ring-opening polymer
The thermal behaviour of the hydrogenated dicyclopentadiene ring-opening polymer was measured using a differential scanning calorimeter (DSC) at a temperature increase rate of 10° C./min.

(5) Ratio of racemo diads in hydrogenated dicyclopentadiene ring-opening polymer
The hydrogenated dicyclopentadiene ring-opening polymer was subjected to 13C-NMR measurement at 200° C. using o-dichlorobenzene-d4/trichlorobenzene (1/2 wt/wt) as a solvent, and the ratio of racemo diads was determined based on the intensity ratio of the signal at 43.35 ppm attributed to meso diads to the signal at 43.43 ppm attributed to racemo diads.

The disclosure is further described with reference to the following non-limiting examples.

### Example 1

### Preparation of the Compound of Formula III

The bispyrrolide precursor W(CHCMe₂Ph)(NAr^{diMe})(Me₂Pyr)₂ (Ar^{diMe}=2,6-dimethylphenyl, Me₂Pyr=2,5-dimethylpyrrolide) (312 mg, 0.5 mmol) was dissolved in benzene (5 mL). Ph(CF₃)₂COH (84 microL, 0.5 mmol) was added, and the reaction mixture was stirred for 30 min at room temperature. An aliquot of the reaction mixture was analyzed by ¹H NMR and ¹⁹F NMR to confirm the formation of the MAP complex. 1,10-Phenantroline (90 mg, 0.5 mmol) was added. The reaction mixture was stirred for an hour at room temperature, and then it was moved into the freezer. Next morning the reaction mixture was thawed, yielding part of the product as orange crystals. Precipitation of the product was completed by slow, gradual addition of pentane (10 mL in total). The reaction mixture and a glass filter were cooled in the freezer, and the product was isolated by rapid filtration. It was washed with pentane on the frit, and dried in N₂ stream. Orange solid. Isolated yield: 480 mg (quantitative).

¹H-NMR (C₆D₆): 0.72 (s, 3H, N—Ar CH₃), 1.77 (s, 3H, CH₃ neophylidene), 1.99 (s, 3H, CH₃ neophylidene), 2.44 (s, 3H, CH₃ 2,5-dimethylpyrrole), 2.53 (s, 3H, N—Ar CH₃), 2.67 (s, 3H, CH₃ 2,5-dimethylpyrrole), 6.45 (d, ³J_{HH}=7.5 Hz 1H, N—Ar Cₘₑₜₐ-H), 6.54 (dd, ³J_{HH}=8.1, 5.0 Hz, 1H, H8-phen), 6.61 (t, ³J_{HH}=7.5 Hz, 1H, N—Ar Cₚₐᵣₐ-H), 6.65 (d, 1H, CH 2,5-dimethylpyrrole),), 6.67 (dd, ³J_{HH}=8.1, 5.2 Hz, 1H, H3-phen), 6.77 (d, 1H, CH 2,5-dimethylpyrrole), 6.93 (d,³J_{HH}=7.5 Hz 1H, N—Ar Cₘₑₜₐ-H), 6.99 (d, 1H, H5-phen), 7.00 (d, 1H, H6-phen), 7.15 (m, 2H, neophylidene Ph Cₚₐᵣₐ-H, (C₆F₅)₂CH₃CO Cₚₐᵣₐ-H), 7.17 (m, 1H, H7-phen) 7.29 (m, 4H, neophylidene Ph Cₘₑₜₐ-H, (C₆F₅)₂CH₃CO Cₘₑₜₐ-H), 7.36 (m, 1H, H4-phen), 7.70 (m, 4H, neophylidene Ph Cₒᵣₜₒ-H, (C₆F₅)₂CH₃Cₒᵣₜₒ-H), 8.77 (d, ³J_{HH}=5.0 Hz, 1H, H2-phen), 9.61 (dd, ³J_{HH}=5.2 Hz, ⁴J_{HH}=1.5 Hz, 1H, H9-phen), 11.99 ppm (s, 1H, W=CH,²J_{WH}=10.0 Hz).
¹⁹F-NMR (C₆D₆): −72.9 (q), −74.6 ppm (q).
¹³C{¹H}-NMR (C₆D₆): 17.6 (N—Ar CH₃), 18.3 (N—Ar CH₃), 20.2 (CH₃ 2,5-dimethylpyrrole), 30.1 (CH₃ neophylidene), 34.8 (CH₃ neophylidene), 108.6 (CH 2,5-dimethylpyrrole), 109.9 (CH 2,5-dimethylpyrrole), 123.7 (C3-phen), 124.0 (C8-phen), 124.1 (N—Ar Cₚₐᵣₐ), 125.2 (C6-phen), 126.4 (N—Ar Cₘₑₜₐ), 128.7 (N—Ar Cₘₑₜₐ) 137.0 (C7-phen), 138.1 (C4-phen), 152.7 (C2-phen), 160.0 ppm (C9-phen).

### Example 2

### Preparation of the Compound of Formula IV

The bispyrrolide precursor W(CHCMe₂Ph)(NAr^{diiPr})(Me₂Pyr)₂ (Ar^{diiPr}=2,6-diisopropylphenyl, Me₂Pyr=2,5-dimethylpyrrolide) (680 mg, 1 mmol) was dissolved in benzene (10 mL). Ph(CF₃)₂COH (170 microL, 1 mmol) was added, and the reaction mixture was stirred for an hour at room temperature. An aliquot of the reaction mixture was analyzed by ¹H and ¹⁹F NMR, which confirmed the formation of the MAP complex. 1,10-Phenantroline (180 mg, 1 mmol) was added. The reaction mixture was stirred for an hour at room temperature. An aliquot was analyzed by ¹H and ¹⁹F NMR. Both methods confirmed the formation of one single stereoisomer of the target compound. The compound was spectroscopically pure. The solution of the complex was concentrated to ca. 3-4 mL. Pentane was added to room temperature. Precipitation of the target compound started after adding ca. 15 mL pentane. Some more pentane (ca. 10 mL) was added to complete precipitation. The mixture was stirred for an hour. The solids were isolated by filtration, washed with pentane, and dried first in N₂ stream, and then in vacuum. Ocher solid. Yield: 936 mg (93%). The product was prepared from the isolated MAP complex, too, with similar yields.

¹H-NMR (C₆D₆): −0.20 (d, ³J_{HH}=6.9 Hz, 6H, CH₃CHCH₃), 0.12 (d, ³J_{HH}=6.9 Hz, 6H, CH₃CHCH₃), 1.22 (d, ³J_{HH}=6.7 Hz, 6H, CH₃CHCH₃), 1.41 (d, ³J_{HH}=6.7 Hz, 6H, CH₃CHCH₃), 1.89 (s, 3H, CH₃ neophylidene), 2.20 (sept, ³J_{HH}=6.9 Hz, 1H, CH₃CHCH₃), 2.24 (s, 3H, CH₃ neophylidene), 2.36 (s, 3H, CH₃ 2,5-dimethylpyrrole), 2.74 (s, 3H, CH₃ 2,5-dimethylpyrrole), 4.25 (sept, ³J_{HH}=6.7 Hz, 1H, CH₃CHCH₃), 6.51 (dd, ³J_{HH}=8.1, 5.0 Hz, 1H, H8-phen), 6.63 (d, ³J_{HH}=2.7 Hz, 1H, CH 2,5-dimethylpyrrole), 6.63 (dd, ³J_{HH}=8.1, 5.2 Hz, 1H, H3-phen), 6.65 (d, ³J_{HH}=7.7 Hz 1H, N—Ar Cₘₑₜₐ-H), 6.69 (d, ³J_{HH}=2.7 Hz, 1H, CH 2,5-dimethylpyrrole),), 6.82 (t, ³J_{HH}=7.7 Hz, 1H, N—Ar Cₚₐᵣₐ-H), 7.00 (ABd, 2H, H5-phen, H6-phen), 7.14-7.20 (m, 2H, neophylidene Ph Cₚₐᵣₐ-H, OCPh(CF₃)₂ Cₚₐᵣₐ-H), 7.15 (d, ³J_{HH}=7.7 Hz 1H, N—Ar C_{meta-H),} 7.17 (m, 1H, H7-phen), 7.29 (m, 2H, OCPh(CF₃)₂ Cₘₑₜₐ-H), 7.34 (m, 1H, H4-phen), 7.37 (m, 2H, neophylidene Ph Cₘₑₜₐ-H), 7.60 (m, 2H, OCPh(CF₃)₂ Cₒᵣₜₒ-H), 7.81 (m, 4H, neophylidene Ph Cₒᵣₜₒ-H), 9.04 (d br, ³J_{HH}=5.1 Hz, 1H, H2-phen), 9.71 (dd, ³J_{HH}=5.0 Hz, ⁴J_{HH}=1.2 Hz, 1H, H9-phen), 12.20 ppm (s, 1H, W=CH, ²J_{WH}=9.5 Hz).
¹⁹F NMR (C₆D₆): −69.1 (q), −76.3 ppm (q br).

### Example 3

### Preparation of the Compound of Formula V

The bispyrrolide precursor W(CHCMe₂Ph)(NAr^{diMe})(Me₂Pyr)₂ (Ar^{diMe}=2,6-dimethylphenyl, Me₂Pyr=2,5-dimethylpyrrolide) (156 mg, 0.25 mmol) was dissolved in toluene (10 mL). The solution was cooled to −38 Celsius in the freezer of the glove box. The solution was moved out of the glove box, and (CF₃)₃COH (35 microL, 0.25 mmol) was added immediately at intensive stirring. The reaction mixture was allowed to warm to room temperature, and and it was left stirring overnight. An aliquot of the reaction mixture was analyzed by ¹H and ¹⁹F NMR. The analysis confirmed the formation of the MAP complex, and also revealed the formation of a small amount of bisalkoxide (ca. 5 mol %). 1,10-phenantroline (45 mg, 0.25 mmol was added. The reaction mixture turned brownish red immediately. Phenantroline residues were washed into the reaction mixture with toluene (1 mL). The reaction mixture was stirred for an hour. An aliquot of the reaction mixture was analyzed by ¹H and ¹⁹F NMR. The analysis confirmed the formation of the phenantroline adduct of the MAP complex, and also revealed the formation of a small amount of the phenantroline adduct of the bisalkoxide (ca. 5 mol %). The reaction mixture was concentrated to 1-2 mL, and precipitation of the product was initiated by the slow addition of pentane (ca. 10 mL). The mixture was stirred for an hour at room temperature to triturate the product, and then the reaction mixture was moved into the freezer to complete the precipitation of the target compound. The product was isolated by filtration, and dried on the frit in N₂ stream. Red solid. Yield: 200 mg (85%). Purity>95%.

¹H-NMR (C₆D₆) δ (ppm): 0.62 (s, 3H, CH₃), 1.82 (s, 3H, CH₃), 1.95 (s, 3H, CH₃), 2.19 (s, 3H, CH₃), 2.47 (s, 3H, CH₃), 3.16 (s, 3H, CH₃), 6.38-7.35 (m, 14H, aromatic), 7.69 (m, 2H, Cₒᵣₜₕₒ-H neophylidene), 8.60 (dd, J=5.2, 1.4 Hz, 1H, H2 Phen), 9.32 (d br, J=5.0 Hz, 1H, H2′ Phen), 12.04 (s, ²J_{WH}=10.9 Hz, 1H, W=CH).

¹⁹F-NMR (C₆D₆) δ (ppm): −72.9 (s).

### Example 4

### Preparation of the Compound of Formula VI

The compound of Formula VI was prepared from W(CHCMe₂Ph)(NAr^{diMe}) (Me₂Pyr)₂ (Ar^{diMe}=2,6-dimethylphenyl, Me₂Pyr=2,5-dimethylpyrrolide) and (CCl₃)(CF₃)₂COH by the method of Example 3. Yield 83%.

¹H-NMR (C₆D₆): δ 0.56 (s, 3H, N—Ar CH₃), 1.81 (s, 3H, CH₃ neophylidene), 1.93 (s, 3H, CH₃ neophylidene), 2.17(s, 3H, CH₃ Me₂Pyr), 2.43 (s, 3H, N—Ar CH₃), 3.17 (s, 3H, CH₃ Me₂Pyr), 6.40 (d br, ³J_{HH}=7.3 Hz, 1H, N—Ar Cₘₑₜₐ-H), 6.58 (m, 2H, H3-phen, N—Ar Cₚₐᵣₐ-H), 6.63 (m, 1H, CH Me₂Pyr), 6.66 (m, 1H, CH Me₂Pyr), 6.65 (m, 1H, H3′-phen), 6.86 (d br,³J_{HH}=7.6 Hz, 1H, N—Ar Cₘₑₜₐ-H), 6.97 (ABq, 2H, H5-phen, H5′-phen), 7.13 (m, 1H, neophylidene Ph Cₚₐᵣₐ-H), 7.16 (m, 1H, H4′-phen), 7.31 (m, 3H, neophylidene Ph Cₘₑₜₐ-H, H4-phen), 7.68 (m, 2H, neophylidene Ph Cₒᵣₜₒ-H), 8.57 (dd, J_{HH}=5.2, 1.1 Hz, 1H, H2-phen), 9.52 (d br, J_{HH}=4.8 Hz, 1H, H2′-phen), 12.34 ppm (s, 1H, W=CH, ²J_{WH}=12.0 Hz).

¹⁹F-NMR (C₆D₆): δ −65.2 (q, ⁴J_{FF}=10.5 Hz), −68.0(q, ⁴J_{FF}=10.5 Hz).

¹³C-NMR (C₆D₆): δ 16.7 (N—Ar CH₃), 19.0 (N—Ar CH₃), 20.6 (CH₃ Me₂Pyr), 21.2 (CH₃ Me₂Pyr) 30.2 (CH₃ neophylidene), 34.7 (CH₃ neophylidene), 55.1 (C neophylidene), 107.7 (CH Me₂Pyr), 110.8 (CH Me₂Pyr), 123.8 (C3-phen), 124.5 (C3′-phen), 124.9 (N—Ar Cₚₐᵣₐ), 125.5 (C5-phen), 126.0 (neophylidene Ph Cₚₐᵣₐ), 127.0 (N—Ar Cₘₑₜₐ), 126.9 (neophylidene Ph Cₒᵣₜₕₒ), 126.8 (C5′-phen), 128.3 (neophylidene Ph Cₘₑₜₐ), 128.7 (C4a′-phen, N—Ar Cₘₑₜₐ), 129.2 (C4a-phen), 133.7 (N—Ar Cₒᵣₜₕₒ), 137.6 (C4′-phen), 138.4 (C4-phen), 140.4 (N—Ar Cₒᵣₜₕₒ), 145.0 (C1a′-phen), 147.2 (C1a-phen), 153.5 (neophylidene Ph Cᵢₚₛₒ), 154.4 (N—Ar Cᵢₚₛₒ), 155.3 (C2′-phen), 160.1 (C2-phen), 287.4 ppm (W=CH).

### Example 5

A glass reactor equipped with a stirrer was charged with 0.072 g (1/500 mol/mol) of (2-trifluoromethyl-2-phenyl-1,1,1-trifluoroethoxy)2,6-dimethylphenylimidotungsten(VI) (2,5-dimethylpyrrolido)(neophylidene)(1,10-phenanthroline) obtained in Example 1, and 1 g of toluene. After the addition of 5.0 g of dicyclopentadiene, 20.0 g of cyclohexane, 0.21 g of 1-hexene, and a solution prepared by dissolving 0.0105 g of anhydrous zinc chloride in 5 g of 1,4-dioxane, a polymerization reaction was performed at 50° C. White turbidity due to 1,10-phenanthroline-zinc was observed immediately after the initiation of the polymerization reaction. After 3 hours had elapsed, a large quantity of acetone was poured into the reaction mixture to aggregate the precipitate, and the aggregate was filtered off, washed, and dried at 40° C. for 24 hours under reduced pressure. The yield of the resulting ring-opening polymer was 4.3 g, and the ring-opening polymer had a number average molecular weight of 14,000 and a cis content of 97%.

A glass reactor equipped with a stirrer was charged with 2.5 g of the resulting dicyclopentadiene ring-opening polymer and 21 g of p-toluenesulfonylhydrazide. After the addition of 500 ml of p-xylene, a hydrogenation reaction was performed at 125° C. for 5 hours. The reaction mixture was poured into a large quantity of methanol to completely precipitate the resulting hydrogenated dicyclopentadiene ring-opening polymer, which was filtered off, washed, and dried at 40° C. for 24 hours under reduced pressure. The hydrogenation ratio of the resulting hydrogenated ring-opening polymer was 99% or more, and the ratio of racemo diads in the hydrogenated ring-opening polymer was 92% and syndiotactic. DSC analysis of the obtained hydrogenated ring-opening polymer showed a melting point, suggesting its crystalline nature.

### Example 6

A glass reactor equipped with a stirrer was charged with 0.076 g (1/500 mol/mol) of (2-trifluoromethyl-2-phenyl-1,1,1-trifluoroethoxy)2,6-diisopropylphenylimidotungsten(VI) (2,5-dimethylpyrrolido)(neophylidene)(1,10-phenanthroline) obtained in Example 2, and 1 g of toluene. After the addition of 5.0 g of dicyclopentadiene, 20.0 g of cyclohexane, 0.21 g of 1-hexene, and a solution prepared by dissolving 0.0105 g of anhydrous zinc chloride in 5 g of 1,4-dioxane, a polymerization reaction was performed at 50° C. White turbidity due to 1,10-phenanthroline-zinc was observed immediately after the initiation of the polymerization reaction. After 3 hours had elapsed, a large quantity of acetone was poured into the reaction mixture to aggregate the precipitate, and the aggregate was filtered off, washed, and dried at 40° C. for 24 hours under reduced pressure. The yield of the resulting ring-opening polymer was 4.4 g, and the ring-opening polymer had a number average molecular weight of 10,900 and a cis content of 81%.

A glass reactor equipped with a stirrer was charged with 2.5 g of the resulting dicyclopentadiene ring-opening polymer and 21 g of p-toluenesulfonylhydrazide. After the addition of 500 ml of p-xylene, a hydrogenation reaction was performed at 125° C. for 5 hours. The reaction mixture was poured into a large quantity of methanol to completely precipitate the resulting hydrogenated dicyclopentadiene ring-opening polymer, which was filtered off, washed, and dried at 40° C. for 24 hours under reduced pressure. The hydrogenation ratio of the resulting hydrogenated ring-opening polymer was 99% or more, and the ratio of racemo diads in the hydrogenated ring-opening polymer was 78% and syndiotactic. DSC analysis of the obtained hydrogenated ring-opening polymer showed a melting point, suggesting its crystalline nature.

### Example 7

A glass reactor equipped with a stirrer was charged with 0.072 g (1/500 mol/mol) of (nonafluoro-tert-butyl alkoxy)2,6-dimethylphenylimidotungsten(VI) (2,5-dimethylpyrrolido)(neophylidene)(1,10-phenanthroline) obtained in Example 3, and 1 g of toluene. After the addition of 5.0 g of dicyclopentadiene, 20.0 g of cyclohexane, 0.21 g of 1-hexene, followed by a solution of 0.0105 g of anhydrous zinc chloride in 5 g of 1,4-dioxane, a polymerization reaction was performed at 50° C. White turbidity due to the presence of 1,10-phenanthroline-zinc was observed immediately after the initiation of the polymerization reaction. After 1 hour had elapsed, a large quantity of acetone was poured into the reaction mixture to aggregate the precipitate, and the aggregate was filtered off, washed, and dried at 40° C. for 24 hours under reduced pressure. The yield of the resulting ring-opening polymer was 4.7 g, and the ring-opening polymer had a number average molecular weight of 5,500 and a cis content of 94%.

A glass reactor equipped with a stirrer was charged with 2.5 g of the resulting dicyclopentadiene ring-opening polymer and 21 g of p-toluenesulfonylhydrazide. After the addition of 500 ml of p-xylene, a hydrogenation reaction was performed at 125° C. for 5 hours. The reaction mixture was poured into a large quantity of methanol to completely precipitate the resulting hydrogenated dicyclopentadiene ring-opening polymer, which was filtered off, washed, and dried at 40° C. for 24 hours under reduced pressure.

The hydrogenation ratio of the resulting hydrogenated ring-opening polymer was in excess of 99% and the ratio of racemo diads in the hydrogenated ring-opening polymer was 93% and syndiotactic. DSC analysis of the obtained hydrogenated ring-opening polymer showed a melting point, suggesting its crystalline nature.

### Example 8

A glass reactor equipped with a stirrer was charged with 0.072 g (1/500 mol/mol) of Mo(CHCMe₂Ph)(NAr^{diiPr})(OCMe(CF₃)₂)₂(1,10-phenantroline), obtained as described in Angew. Chem. Int. Ed. 2011, 50, 8829-7832, and 1 g of toluene. After the addition of 5.0 g of dicyclopentadiene, 20.0 g of cyclohexane, 0.21 g of 1-hexene, followed by a solution of 0.0105 g of anhydrous zinc chloride in 5 g of 1,4-dioxane, a polymerization reaction was performed at 50° C. White turbidity due to the presence of 1,10-phenanthroline-zinc was observed immediately after the initiation of the polymerization reaction. After 1 hour had elapsed, a large quantity of acetone was poured into the reaction mixture to aggregate the precipitate, and the aggregate was filtered off, washed, and dried at 40° C. for 24 hours under reduced pressure. The yield of the resulting ring-opening polymer was 4.6 g, and the ring-opening polymer had a number average molecular weight of 3,800 and a cis content of 66%.

A glass reactor equipped with a stirrer was charged with 2.5 g of the resulting dicyclopentadiene ring-opening polymer and 21 g of p-toluenesulfonylhydrazide. After the addition of 500 ml of p-xylene, a hydrogenation reaction was performed at 125° C. for 5 hours. The reaction mixture was poured into a large quantity of methanol to completely precipitate the resulting hydrogenated dicyclopentadiene ring-opening polymer, which was filtered off, washed, and dried at 40° C. for 24 hours under reduced pressure.

The hydrogenation ratio of the resulting hydrogenated ring-opening polymer was 99% or more, and the ratio of racemo diads in the hydrogenated ring-opening polymer was 39% and not syndiotactic (iso-biased). DSC analysis of the obtained hydrogenated ring-opening polymer showed no melting point, suggesting its amorphous nature.

1. A compound of the formula II 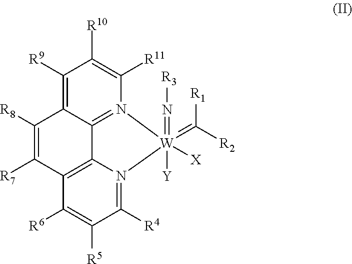
in which
X is substituted pyrrolide with the general structure of 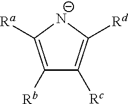
in which R^{a}-R^{d} are independently selected from H, C1-C4 alkyl, C1-C4 alkoxy, aryl, aryloxy, dialkylamino, diarylamino, halogen, trifluoromethyl, cyano, nitro, sulfonyl and sulfinyl;
Y is selected from C1-C6 alkoxy and C1-C10 aryloxy, both of which may be substituted with alkoxy, aryloxy, dialkylamino, diarylamino, halogen, trifluoromethyl, cyano, nitro, sulfonyl and sulfinyl
R¹ is selected from H, C1-C12 alkyl and 5- to 18-membered aryl, both of which may be substituted with one or more of C1-C12-alkyl, 5- to 18-membered aryl, C1-C12-alkyloxy, di-(C1-C4-alkyl)amino, halogen, trifluoromethyl, cyano and nitro residues;
R² is selected from C1-C12-alkyl and 5- to 18-membered aryl, both of which may be substituted with one or more of C1-C12 alkyl, 5- to 18-membered aryl, C1-C12-alkyloxy, di(C1-C4alkyl)amino, halogen, trifluoromethyl, cyano, nitro residues;
R³ is selected from C1-C12 alkyl and 5- to 18-membered aryl, both of which may be substituted with one or more of C1-C12 alkyl, 5- to 18-membered aryl, C1-C12-alkoxy, di(C1-C4-alkyl)amino, halogen, trifluoromethyl, cyano and nitro residues; and,
R⁴-R¹¹ are independently selected from H, C1-C4 alkyl and halogen.

2. A compound according to claim 1, in which:
in X, R^{b} and R^{c} are H, and R^{a} and R^{d} are independently selected from H, methyl and phenyl;
R¹ and R² are selected from H, C1-C5 alkyl and 5- to 10-membered aryl, which may be substituted with one or more of C1-C4-alkyl, halogen and trifluoromethyl, with the proviso that only one of R¹ and R² can be H;
R³ is selected from C1-C5 alkyl and 5- to 10-membered aryl, both of which may be substituted with one or more of C1-C4 alkyl, 5- to 10-membered aryl and C1-C4-alkoxy; and
R⁴-R¹¹ are independently selected from H, C1-C4 alkyl and halogen.

3. A compound according to claim 2, in which
in X, R^{b} and R^{c} are H, and R^{a} and R^{d} are both methyl or both phenyl;
R¹ and R² are selected such that one of them is H and the other is selected from C1-C5 alkyl and 5- to 10-membered aryl, which may be substituted with one or more of C1-C4-alkyl, halogen and trifluoromethyl;
R³ is selected from C1-C5 alkyl and 5- to 10-membered aryl, which may be substituted with one or more of C1-C4 alkyl, 5- to 10-membered aryl, C1-C4-alkoxy, halogen, and trifluoromethyl;
R⁴-R¹¹ are hydrogen.

4. A compound according to claim 1, selected from compounds of the Formulae III-VI:

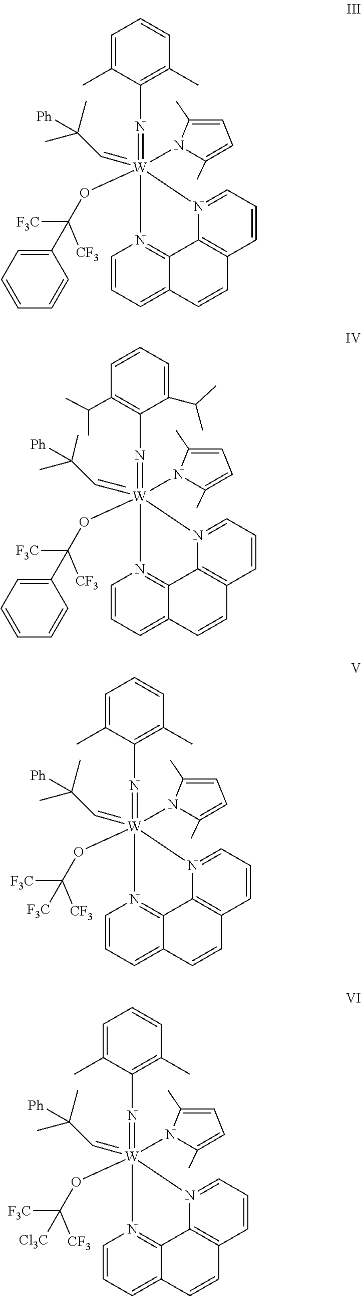

5. A compound according to claim 1, selected from the compounds of the Formulae III-V:

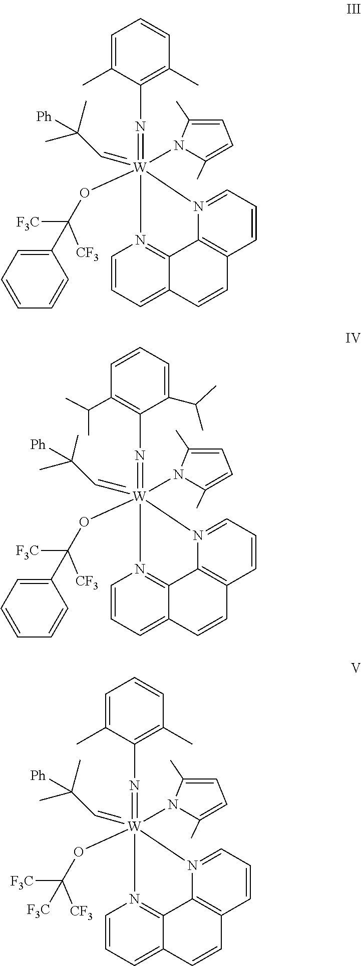

6. Use of a compound according to claim 1 in the preparation of a polymer of dicyclopentadiene.
